(19) United States
(12) Patent Application Publication
(10) Pub. No.: US 2020/0264702 A1
(43) Pub. Date: Aug. 20, 2020

(54) INPUT DEVICE AND ELECTRONIC DEVICE COMPRISING SAME

(71) Applicant: MODA-INNOCHIPS CO., LTD., Ansan-Si, Gyeonggi-Do (KR)

(72) Inventors: Sung Chol PARK, Ansan-Si, Gyeonggi-Do (KR); Young Sul KIM, Seoul (KR); Yu Hyeong LEE, Hwaseong-Si, Gyeonggi-Do (KR); In Seob JEONG, Ansan-Si, Gyeonggi-Do (KR); Wan PARK, Ansan-Si, Gyeonggi-Do (KR)

(21) Appl. No.: 15/781,470

(22) PCT Filed: Dec. 13, 2016
(86) PCT No.: PCT/KR2016/014584

§ 371 Date: Jun. 4, 2018

(30) Foreign Application Priority Data
Dec. 24, 2015 (KR) 10-2015-0186696
Nov. 30, 2016 (KR) 10-2016-0161829

(51) Int. Cl. G06F 3/01; G06F 3/041; H04M 1/02; B06B 1/06

(52) U.S. Cl. CPC G06F 3/016; B06B 1/0651; H04M 1/026; G06F 3/041

(57) ABSTRACT

Provided is an input device. The input device includes a piezoelectric vibration member; a frame disposed to contact at least one area of the piezoelectric vibration member; and a connection member disposed on one surface of the piezoelectric vibration member. The piezoelectric vibration member detects a pressure applied from the outside to generate a voltage and is vibrated in accordance with a signal applied from an external device.

### TECHNICAL FIELD

The present disclosure relates to an input device, and more particularly, to an input device that detects a user's input to perform a corresponding function and feeds back vibration in accordance with the user's input to perform a multifunction and an electronic device having the same.

### BACKGROUND ART

Mobile terminals are portable appliances having one or more functions of a voice and image communication function, an information input/output function, and a data storage function. Also, as the mobile terminal is diversified in function, the mobile terminal is being realized as the form of a multimedia player having complex functions such as, for example, photograph or video shooting, music or moving picture file playing, receiving of broadcasting, games, and the like. New attempts in terms of hardware or software are being variously applied to mobile terminals to realize complex functions of the multimedia player. For example, user interface environments for allowing the user to more easily and conveniently search or select the functions are being provided.

Also, since mobile terminals are considered as personal belongings for expressing one's own individuality, various designical shapes are being required. The designical shapes include structural modification and deformation for allowing the user to more easily use the mobile terminals. A user input unit may be considered as one of the structural modification and deformation.

For example, the user input unit is realized as a touch screen on a front surface of the terminal or a key that is separately provided to receive the user's input. However, the touch screen has a disadvantage in which a target to be manipulated is curved by a finger or stylus pen. The key that is separately provided on the front or side surface of the terminal to solve the disadvantage may hinder a slim and simple design of the terminal. Thus, a user input unit having a new structure that is capable of solving the disadvantages may be required.

### PRIOR ART DOCUMENTS

### Korean Patent Publication No. 2014-0137667

### DISCLOSURE OF THE INVENTION

### Technical Problem

The present disclosure provides a multifunctional input device having at least two or more functions and an electronic device having the same.

The present disclosure also provides an input device provided in an electronic device and having an input detecting function and a feedback function and the electronic device having the same.

The present disclosure also provides an input device that detects a user's input to generate a predetermined signal, performs a predetermined function of an electronic device, and generates vibration feedback in accordance with detection of the user's input.

### Technical Solution

In accordance with an exemplary embodiment, an input device includes: a piezoelectric vibration member; a frame disposed to contact at least one area of the piezoelectric vibration member; and a connection member disposed on one surface of the piezoelectric vibration member, wherein the piezoelectric vibration member detects a pressure applied from the outside to generate a voltage and is vibrated in accordance with a signal applied from an external device.

The frame may include: a first cover disposed to face one surface of the piezoelectric vibration member; a second cover spaced apart from a side surface of the piezoelectric vibration member and disposed to contact one area of the first cover; and a third cover contacting at least a portion of the other surface of the piezoelectric vibration member and disposed to contact one area of the second cover.

The connection member may be disposed between the first cover and the piezoelectric vibration member.

The frame may cover at least a portion of one surface from a side surface of the piezoelectric vibration member.

The frame may be disposed to support an edge of the other surface of the piezoelectric vibration member.

The piezoelectric vibration member may be provided as at least two piezoelectric vibration members spaced apart from each other, and a wiring part may be disposed on each of the at least two piezoelectric vibration members to connect the piezoelectric vibration members to each other.

In accordance with another exemplary embodiment, an electronic device including a front case and a rear case includes an input device disposed between the front case and the rare case, wherein at least a portion of the input device is exposed to the outside.

The input device may include: a piezoelectric vibration member; a frame disposed to contact at least one area of the piezoelectric vibration member; and a connection member disposed on one surface of the piezoelectric vibration member.

The electronic device may further include a cover case disposed on the rear case, wherein an opening may be defined in the cover case, and the frame may be exposed to the outside through the opening.

The cover case and at least a portion of the frame may have the same plane.

The connection member may be disposed between the piezoelectric vibration member and at least a portion of the frame.

The connection member may be disposed between the piezoelectric vibration member and the cover case.

The piezoelectric vibration member may detect a pressure applied from a user to generate a predetermined voltage and apply the generated voltage to a control unit and be vibrated in accordance with a signal applied from the control unit.

### Advantageous Effects

In the input device in accordance with the exemplary embodiments, the piezoelectric vibration member and the connection member may be provided within the frame provided in a predetermined space of the input device to allow the connection member to connect the piezoelectric vibration member to a portion of the frame. Thus, the user's input may be detected through the input device to generate a predetermined signal, thereby allowing the electronic device to perform a predetermined function, and also, the vibration feedback may be generated in accordance with the signal applied from the electronic device. That is, the user's pressure may be transmitted through a portion of the frame and the connection member to generate a predetermined signal from the piezoelectric vibration member, and the portion of the frame, which is connected to the connection member, may act as the weight body when the piezoelectric vibration member is vibrated to significantly increase the vibration force.

Also, the input device in accordance with the exemplary embodiments may be inserted into the opening defined in the cover case disposed on the rear surface of the portable electronic device such as the smartphone and then fixed to the rear case or may be fixed to the rear case to contact the inner surface of the cover case. Thus, since the input device does not protrude from the surface of the cover case, the electronic device may have the slim and simple design.

### BRIEF DESCRIPTION OF THE DRAWINGS

FIGS. 1 and 2 cross-sectional and perspective views of an input device in accordance with an exemplary embodiment, respectively;

FIG. 3 is front and rear perspective views of an electronic device including the input device in accordance with an exemplary embodiment;

FIG. 4 is a partial cross-sectional view of the electronic device to which the input device is coupled in accordance with an exemplary embodiment;

FIGS. 5 and 6 are cross-sectional and plan views of an input device in accordance with another exemplary embodiment, respectively;

FIG. 7 is a cross-sectional view of an input device in accordance with further another exemplary embodiment;

FIGS. 8 and 9 are cross-sectional and perspective views of an input device in accordance with further another exemplary embodiment, respectively;

FIG. 10 is a cross-sectional view of an input device in accordance with further another exemplary embodiment;

FIG. 11 is a cross-sectional view of an input device in accordance with further another exemplary embodiment; and

FIGS. 12 to 14 are graphs illustrating characteristics of an input device in accordance with an exemplary embodiment.

### MODE FOR CARRYING OUT THE INVENTION

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

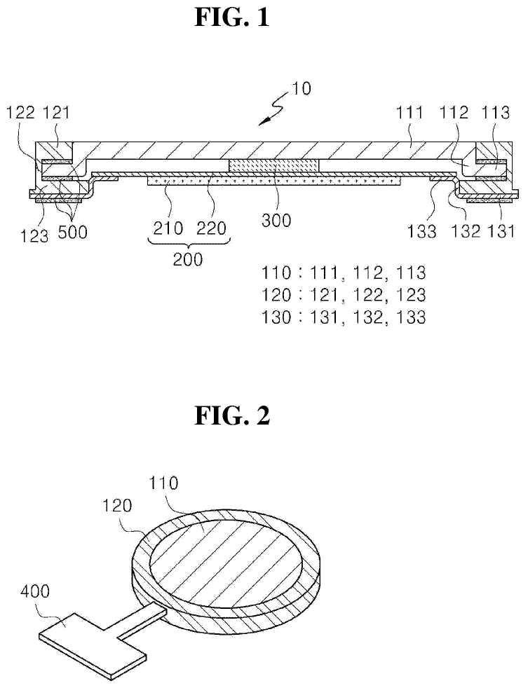

FIG. 1 is a cross-sectional view of an input device in accordance with an exemplary embodiment, and FIG. 2 is a perspective view of the input device.

Referring to FIGS. 1 and 2, an input device 10 in accordance with an exemplary embodiment may include a frame 100 provided in a predetermined space therein and of which at least one region is opened, a piezoelectric vibration member 200 provided in the frame 100, and a connection member 300 provided between the piezoelectric vibration member 200 and a portion of the frame 100. Also, the input device 10 may further include a wiring part 400 connected to the piezoelectric vibration member 200 through at least a portion of the frame 100. Here, the piezoelectric vibration member 200 may include a piezoelectric plate 210 and a vibration plate 220 disposed on one surface of the piezoelectric plate 210. The input device 10 in accordance with an exemplary embodiment may be adopted to an electronic device such as a smartphone to detect user's push or touch so that the piezoelectric vibration member 200 generates a predetermined pressure to apply the generated pressure to a control unit (not shown) of the electronic device, and the control unit may input the predetermined signal transmitted from the piezoelectric vibration member 200 to perform a predetermined function and then or simultaneously, may apply the predetermined signal to the piezoelectric vibration member 200 to allow the piezoelectric vibration member 200 to be vibrated, thereby providing vibration feedback to the user. That is, the input device in accordance with an exemplary embodiment may perform a multifunction including a pressure detection function and a vibration feedback providing function. Each of the components of the input device in accordance with an exemplary embodiment will be described in more detail.

1. Frame

The frame 100 is provided in the predetermined space of the input device 10. The frame may include a first cover 110 disposed on one surface of the piezoelectric vibration member 200, a second cover 120 disposed on a side surface of the piezoelectric vibration member 200, and a third cover 130 disposed on the other surface of the piezoelectric vibration member 200, which faces the first cover 110. Here, an area on which the first cover 110 is disposed will be called a top surface of the piezoelectric vibration member 200, and an area on which the third cover 130 is disposed will be called a bottom surface of the piezoelectric vibration member 200.

The first cover 110 is provided to cover one surface of the piezoelectric vibration member 200, for example, an upper side of the piezoelectric vibration member 200. Thus, the first cover 110 constitutes one side of the input device, i.e., an upper portion of the input device. The first cover 110 may include a planar part 111 having a predetermined thickness in a flat plate shape, a vertical part 112 extending from an edge of the planar part 111 in a direction of the piezoelectric vibration member 200, i.e., in a downward direction, and an extension part 113 extending from the vertical part 112 in a direction that is away from the piezoelectric vibration member 200, i.e., in an outward direction. That is, the first cover 110 may have a predetermined stepped portion downward from the edge of the planar part 111. Also, the planar part 111 of the first cover 110 may be spaced a predetermined distance from the piezoelectric vibration member 200 and thus have a size equal to or greater than that of the piezoelectric vibration member 200. Also, the vertical part 112 may be disposed at a height between the planar part 110 and one surface of the piezoelectric vibration member 200. The first cover 110 may have the same shape as the piezoelectric vibration member 200. That is, the planar part 111 of the first cover 110 may have the same shape as the piezoelectric vibration member 200. For example, as illustrated in FIG. 1, the first cover 110 may have a circular shape. However, the first cover 110 may have various shapes such as a rectangular shape, a square shape, and a polygonal shape in accordance with the shape of the piezoelectric vibration member 200 or the shape of the input device. For example, the first cover 110 may have an elastic coefficient of 1.97×10⁴ kg/cm² to 0.72×10⁶ kg/cm². Also, the first cover 110 may be made of various materials having the above-described elastic coefficient. For example, the first cover 110 may be made of a material such as phosphor bronze, stainless steel, an alloy of iron and nickel (63.5Fe, 36Ni, 0.5Mn, so-called, INVAR), and plastic. Also, the first cover 110 may have a thickness of 0.1 mm to 0.4 mm. The first cover 110 may transmit a pressure generated by the user's push or touch to the piezoelectric vibration member 200 and transmit vibration generated from the piezoelectric vibration member 200 to the user. Also, the first cover 110 provides a weight to the piezoelectric vibration member 200 through the connection member 300 to increase vibration force of the piezoelectric vibration member 200. That is, the first cover 110 may act as a weight body for increasing the vibration of the piezoelectric vibration member 200.

The second cover 120 is spaced apart from the side surface of the piezoelectric vibration member 200. Also, the second cover 120 may be disposed to cover at least a portion of the top and bottom surfaces of the input device. That is, the second cover 120 may be spaced apart from the side surface of the piezoelectric vibration member 200 and then extend from each of upper and lower portions of the piezoelectric vibration member 200. Also, the second cover 120 may have a circular shape in which an opening is defined along an edge of the first cover 110, e.g., a central portion of the first cover 110. That is, the first cover 110 may be disposed inside the second cover 120 having a ring shape in which the opening defined in the central portion. However, the second cover 120 may have a frame shape having various shapes such as a rectangular shape and a square shape with the opening in the central portion thereof in accordance with the shape of the piezoelectric vibration member 200 and the shape of the input device. Also, the second cover may include a first planar part 121 having the same plane as the planar part 111 of the first cover 110, a vertical part 122 spaced apart from the side surface of the piezoelectric vibration member 200 to extend downward from an edge of the first planar part 121, and a second planar part 123 extending from an edge of the vertical part 122 to the piezoelectric vibration member 200. That is, the second cover 120 may include the first and second planar parts 121 and 123 facing each other and the vertical part 122 disposed between the first and second planar parts 121 and 123. Thus, the second cover 120 may have an approximately “1” shape. The first planar part 121 may have a side surface contacting the vertical part 112 of the first cover 110 and a bottom surface contacting the extension part 113 of the first cover 110. Thus, the extension part 113 of the first cover 110 may be accommodated into the second cover 120 having the approximately “⊏” shape. Here, an adhesion member 500 may be disposed between the first and second planar parts 121 and 123 and the vertical part 121 and the extension part 113 of the first cover 110 to bond the first and second covers 110 and 120 to each other. Alternatively, the first and second covers 110 and 112 may be coupled to each other through screw coupling or integrated with each other. The second cover 120 may be made of various materials in accordance with an elastic coefficient. For example, the second cover may have an elastic coefficient of 1.97×10⁴ kg/cm² to 0.72×10⁶ kg/cm² and thus be made of phosphor bronze, stainless steel, or INVAR, which has the elastic coefficient. That is, the second cover 120 may be made of the same material as the first cover 110. Also, the second cover 120 may have a thickness of 0.1 mm to 0.4 mm. Here, the first planar part 121 of the second cover 120 may have a thickness greater than that of the vertical part 122 and equal to or different from that of the second planar part 123. Thus, the second cover 120 may form an outer appearance of the input device to prevent the piezoelectric vibration member 200 from being separated or damaged by an impact. At least one region of the second cover 120 may be cut or opened, and thus, the wiring part 400 may be introduced into the corresponding region. For example, in the second cover 120, an opening having a predetermined size may be defined in a predetermined region of the vertical part 122, and the wiring part 400 may be connected to the second cover 120 through the opening.

The third cover 130 is disposed under the second cover 120. That is, the third cover 130 is disposed under the second planar part 123 of the second cover 120. The third cover 130 may include a first planar part 131 disposed under the second planar part 123 of the second cover 120, a vertical part 132 extending upward along an inner surface of the second planar part 123 of the second cover 120, and a second planar part 133 extending from an edge of the vertical part 132 to the piezoelectric vibration member 200. Here, a top surface of the first planar part 131 of the third cover 131 may contact, for example, adhere to a bottom surface of the second planar part 123 of the second cover 120 by using an adhesion member. For example, the third cover 130 may have an elastic coefficient of 3.97×10⁴ kg/cm² to 0.72×10⁶ kg/cm² and thus be made of phosphor bronze, stainless steel, or INVAR. That is, the third cover 130 may be made of the same material as each of the first and second covers 110 and 120. Also, the third cover 130 may have a thickness of 0.1 mm to 0.4 mm. Here, the third cover 130 may have a thickness less than or equal to that of each of the first and second covers 110 and 120. The third cover 130 may support an edge of the vibration plate 220 of the piezoelectric vibration member 200, be attached to the second cover 120 through welding or adhesion so as to facilitate displacement of the vibration plate 220, and have the same curved shape as the first cover 110 to secure a displacement space of the device when driven.

As described above, the frame 100 has an upper side covered by the first cover 110, a side surface covered by the second cover 120, and a lower side that is partially covered by the third cover 130 to form a predetermined space therein. Also, since the third cover 130 covers only the portion of the lower side of the frame 100, the frame 100 may have a circular opening in a lower portion thereof.

2. Piezoelectric Vibration Member

The piezoelectric member 200 may be provided in the inner space of the frame 100 and include a piezoelectric plate 210 and a vibration plate 220 adhering to one surface of the piezoelectric plate 210.

The piezoelectric plate 210 may have a circular plate shape having a predetermined thickness. Alternatively, the piezoelectric plate 210 may have various shapes such as a square shape, a rectangular shape, an oval shape, and a polygonal shape in addition to the circular shape. That is, the piezoelectric plate 210 may have various shapes in accordance with the shape of the input device. The piezoelectric plate 210 may include a board and a piezoelectric layer disposed on at least one surface of the board. For example, the piezoelectric plate 210 may be provided as a bimorph type piezoelectric device in which the piezoelectric layer is formed on both surfaces of the board or a unimorph type piezoelectric device in which the piezoelectric layer is formed on one surface of the board. At least one layer may be stacked to form the piezoelectric layer. Preferably, a plurality of layers may be stacked on each other to form the piezoelectric layer. Also, an electrode may be disposed on each of upper and lower portions of the piezoelectric layer. That is, the plurality of piezoelectric layer and the plurality of electrodes may be alternately stacked to realize the piezoelectric plate 210. Here, each of the piezoelectric layers may be formed of, for example, a PZT (Pb, Zr, Ti), NKN (Na, K, Nb), BNT (Bi, Na, Ti), or polymer-based piezoelectric material. Also, the piezoelectric layers may be polarized in different directions or the same direction and then be stacked on each other. That is, when the plurality of piezoelectric layers are formed on one surface of the board, the polarizations of each of the piezoelectric layers may be alternately disposed in the different directions or the same direction. The board may be formed of a material having a property in which vibration is generated while maintaining the structure in which the piezoelectric layers are stacked, for example, a metal or plastic. However, the piezoelectric plate 210 may not use the piezoelectric layers and the board. For example, the piezoelectric layer that is not polarized may be disposed on a central portion of the piezoelectric plate 210, and the plurality of piezoelectric layers that are polarized in directions different from each other may be stacked on upper and lower portions of the piezoelectric layer to form the piezoelectric plate 210.

At least a portion of the vibration plate 220 may be fixed to the frame 100. That is, the vibration plate 220 may have an edge having a predetermined width, which is fixed to the third cover 130 of the frame 100, particularly, the second planar part 133 of the third cover 130. Thus, the edge of the vibration plate 220 may be fixed to the second planar part 133 and then coupled by using a screw or adhere by using an adhesive. As a result, since the vibration plate 220 is coupled by using the screw, the vibration plate 220 may be firmly fixed although an impact due to large vibration or collision or a thermal impact due to a high temperature is applied. The vibration plate 220 may be fixed to the frame 100, and the piezoelectric plate 210 may be disposed on one surface of the vibration plate 220, which does not face the first cover 110 of the frame 100. Alternatively, the piezoelectric plate 310 may adhere to the other surface of the vibration plate 220, which faces the first cover 110 of the frame 100. The vibration plate 320 may be manufactured by using metal or plastic, and alternatively, have at least double structure by stacking materials different from each other. For example, the vibration plate 220 may be made of phosphor bronze, stainless steel, or INVAR. For example, the vibration plate 220 may have an elastic coefficient of 220.97×10⁴ kg/cm² to 0.72×10⁶ kg/cm². Here, the piezoelectric plate 210 may have a size less than that of the vibration plate 220. Also, the vibration plate 220 may have a predetermined curved area in addition to the area thereof adhering to the piezoelectric plate 210. That is, the vibration plate 220 outside the area thereof adhering to the piezoelectric plate 210 may have a predetermined curved shape, for example, a shape that is curved downward and then curved upward. Also, the vibration plate 220 may be flat again to the outside of the curved area, and the flat area may contact the frame 100. That is, the vibration plate 220 may have a flat first area contacting the piezoelectric plate 210, a flat second area contacting the frame 100, and a curved third area between the first and second areas.

A waterproof layer (not shown) may be further disposed on at least a portion of the piezoelectric vibration member 200. The waterproof layer may be coated with a waterproof material such as parylene. The parylene may be formed on the top and side surfaces of the piezoelectric plate 210 and the top and side surfaces of the vibration plate 220, which are exposed by the piezoelectric plate 210 in a state in which the piezoelectric plate 210 is bonded to the vibration plate 220. That is, the parylene may be formed on the top and side surfaces of the piezoelectric plate 210 and the vibration plate 220. Also, the parylene may be formed on the top and side surfaces of the piezoelectric plate 210 and the top, side, and bottom surfaces of the vibration plate 220 in the state in which the piezoelectric plate 210 is bonded to the vibration plate 220. That is, the parylene may be formed on the top, side, and bottom surfaces of the piezoelectric plate 210 and the vibration plate 220. As described above, the parylene may be formed on at least one surface of the piezoelectric plate 210 and the vibration plate 220 to prevent moisture from being permeated into the piezoelectric vibration member 200 and prevent the piezoelectric vibration member 200 from being oxidized. Also, since the vibration plate 220 is increased in hardness, a response speed thereof may be improved. Also, a resonant frequency may be adjusted in accordance with a coating thickness of the parylene. Of course, the parylene may be applied to only the piezoelectric plate 210 or the top, side, and bottom surfaces of the piezoelectric plate 210 or be connected to the piezoelectric plate 210 and applied to a power line such as a flexible printed circuit board (FPCB) for supplying power to the piezoelectric plate 210. The parylene may be formed on the piezoelectric plate 210 to prevent moisture from being permeated into the piezoelectric plate 210 and prevent the piezoelectric plate 210 from being oxidized. Also, the formation thickness of the parylene may be adjusted to adjust the resonant frequency. The parylene may be applied to thicknesses different from each other in accordance with the material and characteristic of the piezoelectric plate 210 and the vibration plate 220 and may have a thickness less than that of each of the piezoelectric plate 210 and the vibration plate 220, for example, have a thickness of 0.1 μm to 10 μm. As described above, in order to apply the parylene, for example, the parylene may be primarily heated and evaporated in a vaporizer to become a dimer state and then be secondarily heated and pyrolyzed into a monomer state, and thus, when the parylene is cooled, the parylene may be converted from the monomer state to a polymer state and thus be applied to at least one surface of the piezoelectric vibration member 200. The waterproof layer such as the parylene may be formed on the connection member 300 on the piezoelectric vibration member 300 or formed on at least a portion of the frame 100.

As described above, the piezoelectric vibration member 200 may detect the pressure due to the user's push or touch to generate a predetermined voltage and transmit the generated voltage to the control unit of the electronic device, thereby generating vibration in accordance with a predetermined signal applied to the control unit. That is, the piezoelectric plate 210 may detect the user's pressure to generate a predetermined voltage and transmit the generated voltage to the control unit, and thus, the piezoelectric plate 210 may be vibrated in accordance with the predetermined signal applied from the control unit to amplify the vibration of the vibration plate 220, thereby transmitting the vibration to the user. Thus, the piezoelectric vibration member 200 may function as a pressure sensor having a haptic feedback function.

3. Connection Member

The connection member 300 is disposed between the piezoelectric vibration member 200 and the frame 100. That is, the connection member 300 is disposed between the piezoelectric vibration member 200 and the frame 100. Here, the connection member 300 may be disposed between a central portion of the piezoelectric vibration member 200 and a central portion of the first cover 110. The connection member 300 may have an approximately circular shape along the shape of each of the vibration plate 220 and the first cover 110. However, the connection member 300 may have various shapes such as a rectangular shape, a square shape, and a polygonal shape, but is not limited to a shape thereof. The connection member 300 may be disposed at the central portion of the vibration plate 220 and have an area corresponding to 5% to 50% of an area of the vibration plate 220. When the connection member 300 has an area exceeding 50% of the area of the vibration plate 220, the vibration of the vibration plate 220 may be suppressed, and when the connection member 300 has an area less than 5% of the area of the vibration plate 220, the user's pressure may not be properly transmitted to the vibration member 200, or the vibration of the piezoelectric vibration member 200 may not properly transmitted to the first cover 110, and thus, the weight of the first cover 110 may not be properly transmitted to the vibration plate 220. The connection member 300 may be fixed to at least one of the piezoelectric vibration member 200 and the frame 100 through adhesion or other methods. For example, the connection member 300 may be fixed to the piezoelectric vibration member 200 and may not be fixed to the frame 100, but contact the frame 100 or may be fixed to the frame 100 and may not be fixed to the piezoelectric vibration member 200, but contact the piezoelectric vibration member 200. However, the connection member 300 may be fixed to both of the piezoelectric vibration member 200 and the frame 100 and thus stably fixed. Here, in order to fix the connection member 300 to the piezoelectric vibration member and the frame 100, an adhesive such as a double-sided tape may be used, and the adhesive such as the double-sided tape may have a thickness of 0.05 mm to 1.0 mm. Of course, since the connection member 300 is formed of an adhesion material such as rubber or silicon, the connection member 300 itself may adhere to the piezoelectric vibration member 200 and the frame 100. The connection member 300 may be made of PET, polyurethane, polycarbonate, rubber, silicon, or PORON. Also, the connection member 300 may have hardness of 20 to 90. For example, when the connection member 300 is manufactured by using polycarbonate or PET, the hardness may be 50 to 90, when manufactured by using silicon, the hardness may be 45 to 70, and when manufactured by using PORON, the hardness may be 20 to 70. Since the connection member 300 is provided as described above, a product may be prevented from being damaged when the product drops, or an impact is applied to the product. Also, the vibration of the piezoelectric vibration member may be concentrated to transmit the vibration force without loss of the vibration force, and when the pressure is applied, the force may be concentrated into the device to more easily output the voltage. Also, the weight of the first cover 110 that acts as the weight body may be transmitted to the piezoelectric vibration member 200 to function as a medium for increasing the vibration force of the piezoelectric vibration member 200.

4. Wiring Part

The wiring part 400 may transmit the voltage generated from the piezoelectric vibration member 200 to the control unit (not shown) and apply the signal transmitted from the control unit to the piezoelectric vibration member 200. That is, the wiring part 400 may be disposed between the piezoelectric vibration member 200 and the control unit of the electronic device to transmit the voltage generated from the piezoelectric vibration member 200 to the control unit and supply the signal transmitted from the control unit to the piezoelectric vibration member 200 so that the piezoelectric vibration member 200 functions as a haptic device. Also, the wiring part 400 may be connected to the piezoelectric vibration member 200 through a portion of the frame 100. For example, the wiring part 400 may be connected to the piezoelectric vibration member 200 through the opening defined in at least a portion of the second cover 120 of the frame 100. The wiring substrate 400 may be provided as the FPCB. That is, at least one conductive line may be disposed on a flexible film to form the wiring part 400. Also, the wiring part 400 may be connected to the electronic device. on which the input device is mounted, for example, the mobile terminal to transmit power and/or a signal to the mobile terminal and the input device.

Each of the components constituting the input device may adhere by using the adhesion member. For example, the first cover 110 and the second cover 120 may adhere to each other by the adhesion member 500, and also, the second cover 120 and the third cover 130 may adhere to each other by the adhesion member 500. Also, the vibration plate 220 may adhere to the third cover 130 by the adhesion member, and the connection member 300 may adhere to at least one of the first cover 110 and the vibration plate 220 by the adhesion member. Also, in order to fix the input device to the electronic device, the adhesion member 500 may be disposed on the bottom surface of the third cover 130. Of course, the covers may be bonded to each other through other methods in addition to the adhesion member, e.g., a welding manner.

As described above, in the input device in accordance with an exemplary embodiment, the piezoelectric vibration member 200 and the connection member 300 may be provided in the frame 100 having the predetermined space. Also, the connection member 300 connects the piezoelectric vibration member 200 to a portion of the frame 100. Thus, the user's pressure may be transmitted to the piezoelectric vibration member 200 by the connection member 300, and the portion of the frame 100, which is connected to the connection member 300, may act as the weight body to increase the vibration force of the piezoelectric vibration member 200, and then, the vibration of the piezoelectric vibration member may be transmitted to the frame 100 through the connection member 300. The piezoelectric vibration member 200 of the input device may detect the pressure due to the user's push or touch to generate a predetermined voltage, and the voltage may be supplied to the control unit through the wiring part 400, and then, a signal of the piezoelectric vibration member 200 may be supplied to the control unit through the wiring part 400 to allow the piezoelectric vibration member 200 to perform the haptic feedback function. That is, the input device may realize the pressure sensor and the haptic device at the same time.

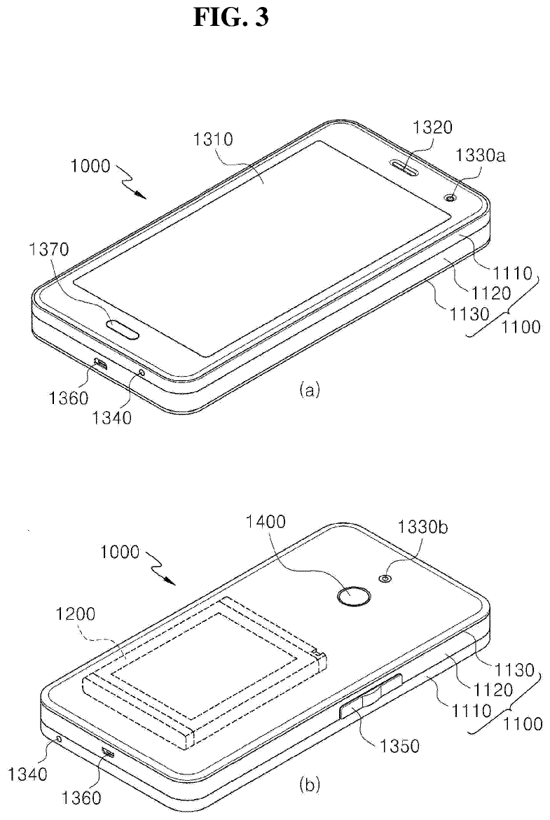

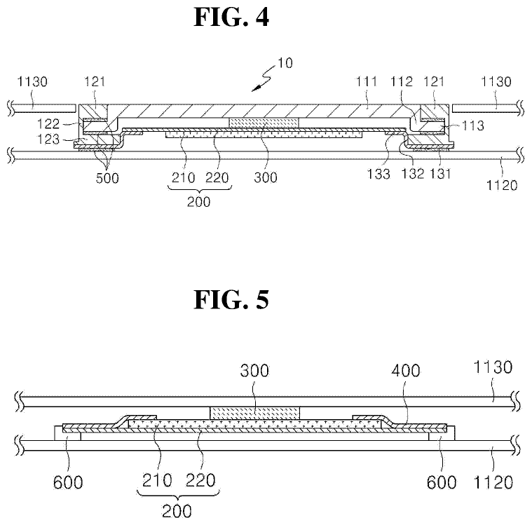

The input device in accordance with an exemplary embodiment may be disposed on a rear surface of the portable electronic device such as the smartphone. The electronic device on which the input device is disposed on the rear surface thereof will be described with reference to FIGS. 3 and 4.

(a) and (b) of FIG. 3 are front and rear perspective views of the electronic device to which the input device is applied in accordance with an exemplary embodiment, respectively. Also, FIG. 4 is a partial cross-sectional view of the electronic device to which the input device is coupled in accordance with an exemplary embodiment.

Referring to FIG. 3, an electronic device 1000 includes a case 1100 defining an outer appearance thereof. The case 1100 may include a front case 1110, a rear case 1120, and a cover case 1130. The case 1100 may be formed by injection-molding a synthetic resin or formed of a metal material, for example, stainless steel (STS), titanium (Ti), aluminum (Al), and the like. Various components such as a circuit board may be built in a space between the front case 1110 and the rear case 1120. Also, a vibration device may be disposed in an outer region between the front case 1110 and the rear case 1120 or between the front case 1110 and a display unit 1310. The vibration device may provide vibration feedback due to user's touch input and may use a vibration motor and a piezoelectric vibration device, preferably, the piezoelectric vibration. Here, the input device described with reference to FIGS. 1 and 2 may be used as the piezoelectric vibration device disposed on a side of the front case 1110.

The display unit 1310, a sound output module 1320, a camera module 1330a may be disposed on the front case 1110. Also, a microphone 1340, a side input unit 1350, and an interface 1360 may be disposed on side surfaces of the front and rear cases 1110 and 1120. The display unit 1310 occupies most front surface of the front case 1110. That is, the display unit 1310 is disposed on a front surface of an electronic device body to output visual information. The sound output module 1320 and the camera module 1330a are disposed above the display unit 1310, and a front input unit 1370 is disposed under the display unit 1310. Also, the display unit 1310 may form a touch screen together with a touch sensor. Here, the piezoelectric vibration device disposed to contact the display unit 1310 may provide feedback in response to user's input or touch. In case in which the touch sensor is provided, the front input unit 1370 may be removed from a front surface of a terminal. In this case, input manipulation with respect to a terminal body of the mobile terminal 1000 may be realized by using the display unit 1310 and the input device in accordance with an exemplary embodiment. The front input unit 1370 may include a touch key and a push key and be manipulated while a user feels tactile feeding. Also, the side input unit 1350 may receive a command for controlling intensity of sound outputted from the sound output module 1320 or a command for switching of a touch recognition mode of the display unit 1310.

A camera module 1330b may be additionally mounted on a rear surface of the terminal body, i.e., the rear case 1120. The camera module 1330b may have a photographing direction different from that of the first camera 1330a and be a camera having a pixel different from that of the camera module 1330a. A flash (not shown) may be disposed adjacent to the camera module 1330b.

A battery 1200 for supplying power to the mobile terminal 1000 is mounted on the terminal body. The battery 1200 may be built in the terminal body or detachably disposed on the outside of the terminal body. Also, a rear input unit 1400 using the input device in accordance with an exemplary embodiment is disposed on a rear surface of the terminal body. For example, the rear input unit 1400 may be disposed adjacent to the camera module 1330b. That is, the battery 1200 and the rear input unit 1400 using the input device in accordance with an exemplary embodiment may be disposed between the rear case 1120 and the cover case 1130. At least a portion of the input device may be inserted into a predetermined region of the rear case 1120 to contact the cover case 1130. For example, as illustrated in FIG. 4, an opening may be defined in the predetermined region of the cover case 1130, and the first cover 110 of the input device may be exposed through the opening. Here, an outer surface of the cover case 1130 and a top surface of the input device may have the same plane. That is, the input device may not protrude outward from the cover case 1130.

The rear input unit 1400 may be manipulated to receive a command for controlling an operation of the mobile terminal 1000, and input contents may be variously set. For example, the rear input unit 1400 may receive commands such as turn on/off of power, start, end, and scroll and commands such as adjustment in intensity of sound outputted from the sound output module 1320 and conversion into the touch recognition mode of the display unit 1310. Also, the input device in accordance with an exemplary embodiment may constitute a portion of the rear input unit 1400 to react with an input of user's command, thereby providing vibration. That is, since the input device is disposed in the predetermined region of the cover case 1130, predetermined vibration may be generated from the piezoelectric plate 210 and the vibration plate 220 of the piezoelectric vibration member 200 in accordance with the user's input, i.e., touch or pressing pressure and then feedback to the user.

FIG. 5 is a cross-sectional view of an input device that is mounted on a rear case of a portable electronic device in accordance with another exemplary embodiment.

Referring to FIG. 5, an input device in accordance with another exemplary embodiment may a piezoelectric vibration member 200 including a piezoelectric plate 210 and a vibration plate 220, a connection member 300 disposed on the piezoelectric vibration member 200, and a support 600 supporting an edge of the piezoelectric vibration member 200. Since constituents of the piezoelectric vibration member 200 and the connection member 300 are duplicated with those described in accordance with an exemplary embodiment, their detailed description will be omitted, and different points with respect to the foregoing embodiment will be mainly described.

The piezoelectric vibration member 200 and the connection member 300 may be disposed above the rear case 1120, and the connection member 300 may contact a cover case 1130. Also, in the piezoelectric vibration member 200, the vibration plate 220 may face the rear case 1120, and the piezoelectric plate 210 may be disposed on the vibration plate 220. Also, the support 600 supporting the piezoelectric vibration member 200 may be disposed on an edge of the piezoelectric vibration member 200, i.e., an edge of the vibration plate 220. The support 600 may support the piezoelectric vibration member 200 and cover the outside of the piezoelectric vibration member 200. The support 600 may have an approximately circular shape along a shape of the vibration plate and support the edge of the vibration plate 220 by a predetermined width thereof. Also, the support 600 may have a predetermined thickness, and thus, the vibration plate 220 and the rear case 1120 may be maintained to a predetermined distance therebetween. For example, the support 600 may have a thickness of 0.1 mm to 0.5 mm, and thus, the rear case 1120 and the vibration plate 220 may be maintained to a distance of 0.1 mm to 0.5 mm. The input device in accordance with another embodiment may not provide a portion of the frame covering the upper side, but support a portion of the side portion. That is, since the connection member 300 is connected to the cover case 1130, a portion of the cover case 1130 may act as a cover member covering the upper side of the input device and also act as a weight body.

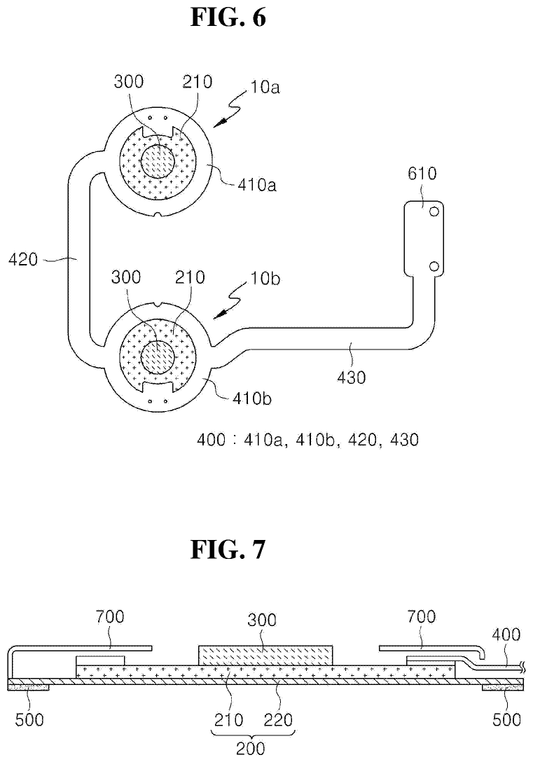

Also, the input device in accordance with another exemplary embodiment may be provided as at least two input devices spaced a predetermined distance from each other. For example, as illustrated in FIG. 6, the input devices may be spaced a predetermined distance from each other to form first and second input devices 10a and 10b. Also, a wiring part 400, i.e., an FPCB may be provided to connect each of the first and second input devices 10a and 10b spaced apart from each other to the piezoelectric plate 210. The wiring part 400 may include first and second wiring parts 410a and 410b provided to connect each of the first and second input devices 10a and 10b to the piezoelectric plate 210, a connection part 420 connecting the first and second wiring parts 410a and 410b to each other, and an extension part 430 extending from at least one of the first and second wiring parts 410a and 410b and connected to a pad part 610. Here, the pad part 610 may be connected to the electronic device, and power or a signal of the electronic device may be applied to the first and second input devices 10a and 10b via the wiring part 400 through the pad part 610.

Although the input device is disposed on the cover case 1130 or the rear case 1120 of the portable electronic device such the smartphone in the foregoing embodiments, the input device may be attached to a mouse pad or a touch screen of a notebook computer and function as a button having a turn on/off function. That is, the input device may be disposed on any area of the electronic device including the input device and simultaneously perform the function as the pressure sensor for generating a predetermined voltage by detecting the user's push or touch and the function as the haptic device providing the feedback to the user.

At least a portion of the input device in accordance with another exemplary embodiment is constituted by a cover member 700 for protecting the piezoelectric vibration member 200. That is, as illustrated in FIG. 7, the cover member 700 spaced apart from the connection member 300 to cover at least a portion of the piezoelectric vibration member 200 may be provided. The cover member 700 may be formed by deforming a portion of the shape of the first cover of the frame 100 in accordance with an exemplary embodiment. That is, the cover member 700 may be a type of frame 100 formed by deforming the frame 100. Here, a top surface of the cover member 700 and a top surface of the connection member 300 may have the same plane. The cover member 700 may be made of phosphor bronze, stainless steel, or INVAR. As described above, since the cover member 700 is provided, damage of the piezoelectric vibration member 200 may be reduced in an assembly process, and when assembled, a bonding surface of the cover member 700 may be attached by welding or an adhesive. The cover member 700 may be formed by deforming the first cover 110 of the frame 100 described in accordance with an exemplary embodiment. That is, the cover member 700 may be formed by deforming at least a portion of the frame 100.

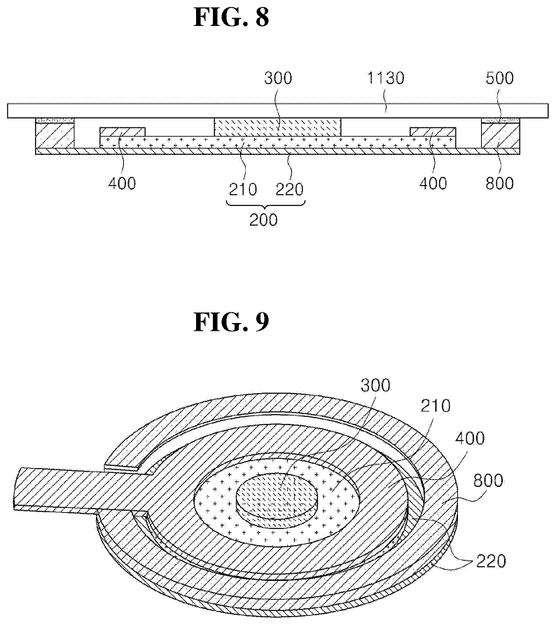

FIG. 8 is a cross-sectional view of an input device in accordance with further another exemplary embodiment, and FIG. 9 is a perspective view of the input device.

Referring to FIGS. 8 and 9, a piezoelectric vibration device in accordance with further another exemplary embodiment may a piezoelectric vibration member 200 including a piezoelectric plate 210 and a vibration plate 220, a connection member 300 disposed on one surface of the piezoelectric vibration member 200, and a module frame 800 disposed along an edge of the vibration plate 220.

Each of the piezoelectric plate 210, the vibration plate 220, and the connection member 300 may have an approximately circular shape with a predetermined thickness, and the module frame 800 may be disposed on the edge of the vibration plate 220. That is, the module frame 800 may have a circular ring shape in which a central portion is opened. The module frame 800 may be formed by deforming the shape of the frame 100. That is, the module frame 800 may be formed by using a portion of a second cover 120 or a portion of a third cover 130, which is disposed under the piezoelectric vibration member 200. Thus, the module frame 800 may be a type of frame 100 formed by deforming the frame 100. The vibration plate 220 may be attached to the module frame 800, and the piezoelectric plate 210 may be disposed above the vibration plate 220 within the module frame 800. Also, the connection member 300 may be disposed on an upper central portion of the piezoelectric plate 210. Here, the connection member 300 may protrude from a surface of the module frame 800. However, when an adhesion member is disposed on the module frame 800, and a cover case 1130 is attached, a surface of the connection member 300 may contact the cover case 1130. That is, when the adhesion member is provided on the module frame 800, the connection member 300 may have the same plane as the adhesion member. The module frame 800 may be formed by deforming the first cover 120 of the frame 100 described in accordance with an exemplary embodiment. That is, the module frame 800 may be formed by deforming at least a portion of the frame 100.

Also, at least one region of the module frame 800 may have an opened structure. That is, as illustrated in FIG. 9, when the module frame 800 has a ring shape, a portion of the module frame 800 may be removed. A wiring part 400 provided as an FPCB may be introduced through the removed region, and the FPCB may be disposed inside the module frame 800. That is, the FPCB may have a ring shape and be disposed inside the module frame, and thus, the FPCB may extend to the outside through the opening of the module frame.

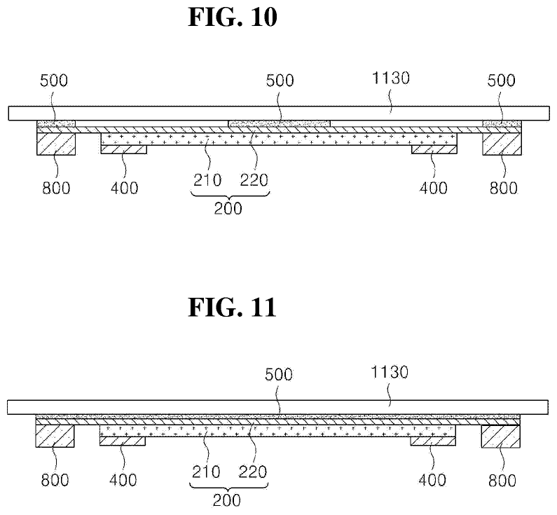

FIG. 10 is a cross-sectional view of a piezoelectric vibration device in accordance with further another embodiment.

Referring to FIG. 10, a piezoelectric vibration device in accordance with further another exemplary embodiment may a piezoelectric vibration member 200 including a piezoelectric plate 210 and a vibration plate 220 and a module frame 800 disposed along an edge of the vibration plate 220.

Each of the piezoelectric plate 210 and the vibration plate 220 may have an approximately circular shape with a predetermined thickness, and the module frame 800 may be disposed on the edge of the vibration plate 220. That is, the module frame 800 may have a circular ring shape in which a central portion is opened. The vibration plate 220 may be attached to the module frame 800, and the piezoelectric plate 210 may be disposed above the vibration plate 220 within the module frame 800. That is, the vibration plate 220 may be attached to an upper portion of the module frame 800, and the piezoelectric plate 210 may be attached to a lower portion of the vibration plate 220. Also, an adhesive 900 may be disposed on an upper central portion of the vibration 220 and on the module frame 800. The adhesive disposed on the upper central portion of the vibration plate 220 may be attached to a cover case 1130 of an electronic device to function as a connection member transmitting vibration of the piezoelectric vibration member 200.

As illustrated in FIG. 11, the adhesive may be disposed on an entire top surface of the vibration plate 220 and an entire top surface of the module frame 800.

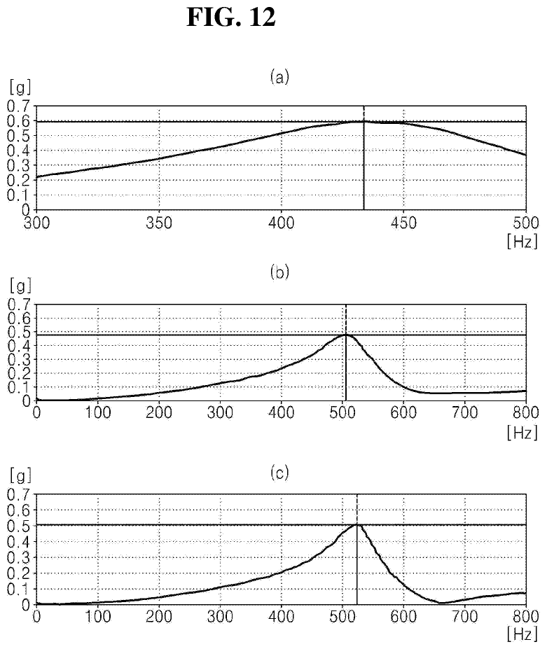

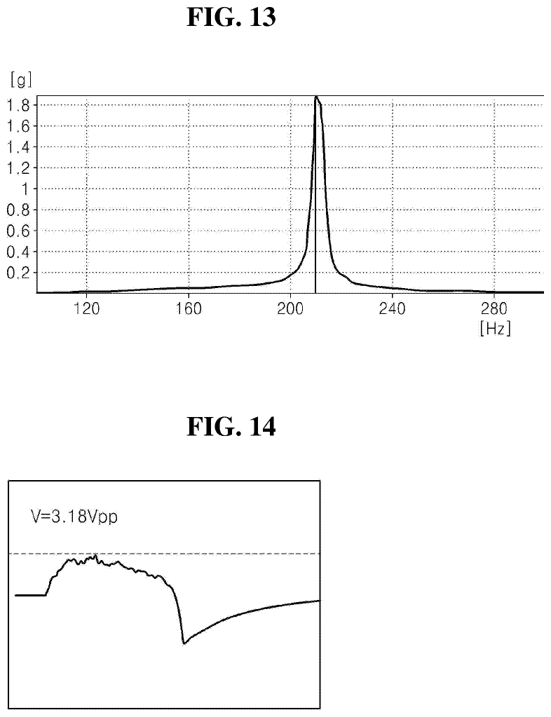

FIGS. 12 to 14 are graphs illustrating characteristics of a piezoelectric vibration device in accordance with an exemplary embodiment, FIG. 12 is a graph illustrating vibration acceleration due to a thickness of a cover case, FIG. 13 is a graph illustrating vibration acceleration in a state in which a jig having a weight of 100 g is mounted, and FIG. 14 is a graph of voltage output characteristics. As illustrated in (a) of FIG. 12, when the cover case has a thickness of 0.2 mm, the vibration acceleration may be 0.591 G, as illustrated in (b) of FIG. 12, when the cover case has a thickness of 0.25 mm, the vibration acceleration may be 0.478 G, and as illustrated in (c) of FIG. 12, when the cover case has a thickness of 0.3 mm, the vibration acceleration may be 0.507 G. Also, as illustrated in FIG. 14, when a load of 100 gf is applied, a voltage of 3 Vpp or more may be outputted.

As described above, the technical idea of the present invention has been specifically described with respect to the above embodiments, but it should be noted that the foregoing embodiments are provided only for illustration while not limiting the present invention. Various embodiments may be provided to allow those skilled in the art to understand the scope of the preset invention, but the present invention is not limited thereto.

1. An input device comprising:
a piezoelectric vibration member;
a frame disposed to contact at least one area of the piezoelectric vibration member; and
a connection member disposed on one surface of the piezoelectric vibration member,
wherein the piezoelectric vibration member detects a pressure applied from the outside to generate a voltage and is vibrated in accordance with a signal applied from an external device.

2. The input device of claim 1, wherein the frame comprises:
a first cover disposed to face one surface of the piezoelectric vibration member;
a second cover spaced apart from a side surface of the piezoelectric vibration member and disposed to contact one area of the first cover; and
a third cover contacting at least a portion of the other surface of the piezoelectric vibration member and disposed to contact one area of the second cover.

3. The input device of claim 2, wherein the connection member is disposed between the first cover and the piezoelectric vibration member.

4. The input device of claim 1, wherein the frame covers at least a portion of one surface from a side surface of the piezoelectric vibration member.

5. The input device of claim 1, wherein the frame is disposed to support an edge of the other surface of the piezoelectric vibration member.

6. The input device of claim 1, wherein the piezoelectric vibration member is provided as at least two piezoelectric vibration members spaced apart from each other, and
a wiring part is disposed on each of the at least two piezoelectric vibration members to connect the piezoelectric vibration members to each other.

7. An electronic device comprising a front case and a rear case, the electronic device comprising:
an input device disposed between the front case and the rare case,
wherein at least a portion of the input device is exposed to the outside.

8. The electronic device of claim 7, wherein the input device comprises:
a piezoelectric vibration member;
a frame disposed to contact at least one area of the piezoelectric vibration member; and
a connection member disposed on one surface of the piezoelectric vibration member.

9. The electronic device of claim 8, further comprising a cover case disposed on the rear case,
wherein an opening is defined in the cover case, and the frame is exposed to the outside through the opening.

10. The electronic device of claim 9, wherein the cover case and at least a portion of the frame have the same plane.

11. The electronic device of claim 8, wherein the connection member is disposed between the piezoelectric vibration member and at least a portion of the frame.

12. The electronic device of claim 9, wherein the connection member is disposed between the piezoelectric vibration member and the cover case.

13. The electronic device of claim 8, wherein the piezoelectric vibration member detects a pressure applied from a user to generate a predetermined voltage and apply the generated voltage to a control unit and is vibrated in accordance with a signal applied from the control unit.
